(19) United States
(12) Patent Application Publication
(10) Pub. No.: US 2014/0092703 A1
(43) Pub. Date: Apr. 3, 2014

(54) MULTI-COMPARTMENT CONTAINER WITH IN CONTAINER MIXING

(71) Applicants: ELIE HELOU, JR., Santa Barbara, CA (US); Heriberto Alvarado, Oxnard, CA (US)

(72) Inventors: ELIE HELOU, JR., Santa Barbara, CA (US); Heriberto Alvarado, Oxnard, CA (US)

(73) Assignee: BIOSPHERE SPIRITS, LLC, Carpinteria, CA (US)

(21) Appl. No.: 13/632,291

(22) Filed: Oct. 1, 2012

(51) Int. Cl. B01F 13/00

(52) U.S. Cl. 366/130

(57) ABSTRACT

A multi-component mixing device comprising an outer container and an inner vessel. The outer container comprises a closed end, a mouth and a peripheral wall between said closed end and said mouth. The inner vessel is disposed within said outer container and the inner vessel comprises a top portion, a bottom portion and a peripheral side wall between said top portion and bottom portion. The peripheral side wall of the inner vessel is defined by first and second sections, which are slidably engaged to one another between a first position and a second position. In the first position, the inner vessel defines an enclosed cavity and in the second position, the inner vessel comprises a first opening corresponding to the enclosed cavity.

### FIELD OF THE INVENTION

The present invention relates to mixing containers and, more particularly, to multi-compartment mixing containers configured to selectively separately store and combine two or more components prior to consuming or pouring.

### BACKGROUND

There are a number of useful compositions which are comprised of two or more components, such as mixed beverages, nutritional supplements, energy drinks, consumer applications such as hair colors, and industrial chemicals. Certain types of compositions, however, suffer from change or degradation within a relatively short time after combining the components comprising the composition. This is often due to the reactivity of the components and/or long-term storage of these types of compositions is not practical. Moreover, certain combinations oxidize or change color over time or when mixed; therefore, it is not desired to separate components of these combinations until just prior to use.

Consumers are more likely to purchase ready-to-use products over those that require preparation. For example, a beverage that requires a consumer to measure and mix multiple components together is more burdensome and less attractive than a beverage that may simply be opened and consumed.

### SUMMARY

Multi-component mixing devices and methods for filling the multi-component mixing device are provided. The multi-component mixing device comprises an outer container and one or more inner vessels disposed within the outer container. The outer container may optionally comprise a closed end, a mouth and a peripheral wall between said closed end and said mouth. The one or more inner vessels may optionally comprise a top portion, a bottom portion and a peripheral side wall between said top portion and bottom portion. The peripheral side wall may be defined by first and second sections, the first and second sections being slidably engaged to one another between a first position and a second position. In the first position, the inner vessel defines an enclosed cavity. In the second position, the inner vessel comprises a first opening corresponding to the enclosed cavity.

In accordance with a first aspect, the multi-compartment mixing device, further comprising a lid adapted to engage and seal the mouth of the outer container.

In accordance with a second aspect, the lid comprises an outer portion directly coupled with the outer container and an inner portion directly coupled to one of the first and second sections of the inner vessel.

In accordance with a third aspect, the other one of the first and second sections of the inner vessel is coupled to one of the outer portion of the lid or the closed end of the outer container.

In accordance with a fourth aspect, the inner portion of the lid is rotatable along a longitudinal axis relative to the outer portion to actuate one of the first and second sections of the inner vessel between the first and second positions.

In accordance with a fifth aspect, the lid further comprises an index to designate the first and second positions.

In accordance with a sixth aspect, the index is a dial configured on the lid.

In accordance with a seventh aspect, the multi-compartment mixing device further comprises a seal between the first and second sections, wherein the seal is fluid-proof, powder-proof and or gel-proof.

In accordance with an eighth aspect, the multi-compartment mixing device further comprises at least one fill hole and at least one closure to seal the at least one fill hole.

In accordance with a ninth aspect, one of the first and second sections is coupled to the closed end of the outer container and the other one of the first and second sections is coupled to the lid.

In accordance with a tenth aspect, the inner vessel comprises a divider between the top and bottom portions and wherein in the first position, the inner vessel comprises two discrete cavities.

In accordance with an eleventh aspect, wherein in the second position, the peripheral side wall comprises a first opening corresponding to a first one of the two discrete cavities.

In accordance with a twelfth aspect, the inner vessel comprises a third position, wherein in the third position, the peripheral side wall comprises a second opening corresponding to a second one of the discrete cavities.

In accordance with a thirteenth aspect, wherein in the third position, the first opening corresponding to the first one of the two discrete cavities is closed.

In accordance with a fourteenth aspect, the inner vessel comprises a plurality of discrete enclosed cavities.

In accordance with a fifteenth aspect, the lid further comprises a mouthpiece.

In accordance with a sixteenth aspect, the mouthpiece is configured to be actuated between an open and a closed state.

In accordance with a seventeenth aspect, the mouthpiece is a nipple.

In another embodiment, a multi-component mixing device is provided. The device comprises an outer container and one or more inner vessels disposed in said outer container. The inner vessels each comprise concentric cylindrical sections, which are rotatable relative to one another to a first and a second position. In the first position, the inner vessel defines an enclosed cavity. In the second position, inner vessel comprises comprise an opening corresponding to the enclosed cavity.

In accordance with a first aspect, the concentric cylinder sections each comprise one or more openings, wherein in said first position, the respective openings of the concentric cylinder sections are not aligned to define the enclosed cavity.

In accordance with a second aspect, the concentric cylinder sections each comprise one or more openings, wherein in said second position, the respective openings of the concentric cylinder sections are aligned to define the opening.

Other objects, features and advantages of the present invention will become apparent to those skilled in the art from the following detailed description.

### BRIEF DESCRIPTION OF THE DRAWINGS

Illustrative embodiments of the present invention are described herein with reference to the accompanying drawings, in which:

FIG. 1 is a top plan view of an embodiment of a mixing container.

FIG. 2 is a cross-sectional view along A-A of the mixing container of FIG. 1.

FIG. 3 is an exploded perspective view of the container of FIG. 1.

FIG. 4 is a side view of one embodiment of an inner vessel.

FIG. 5 is a cross sectional view along B-B of the inner vessel of FIG. 4.

FIG. 6 is a trimetric view of the inner vessel of FIG. 4 in the fully closed or enclosed position.

FIG. 7 is a trimetric view of the inner vessel of FIG. 4 in the fully open position.

FIG. 8 is a top view of a second embodiment of an inner vessel.

FIG. 9 is a side view of the inner vessel of FIG. 8 along C-C.

FIG. 10 is a trimetric view of the inner vessel of FIG. 8 in the closed position.

FIG. 11 is a trimetric view of the inner vessel of FIG. 8 in the fully open position.

FIG. 12 is a top view of a third embodiment of an inner vessel.

FIG. 13 is a section view along D-D of the inner vessel of FIG. 12.

FIG. 14 is a trimetric view of the inner vessel of FIG. 12 in the fully closed position.

FIG. 15 is trimetric view of the inner vessel of FIG. 12 in the fully open position.

FIG. 16 is a top view of a fourth embodiment of an inner vessel.

FIG. 17 is a cross-sectional view along E-E of the inner vessel of FIG. 16 in the closed position.

FIG. 18 is a side view along F-F of the inner vessel of FIG. 17.

FIG. 19 is a cross sectional view along G-G of the inner vessel in FIG. 18.

FIG. 20 is trimetric view of the inner vessel of FIG. 16 in the fully open position.

FIG. 21 is a top view of a fifth embodiment of an inner vessel.

FIG. 22 is a cross-sectional view of the inner vessel along H-H of FIG. 21.

FIG. 23 is a side view of the inner vessel of FIG. 22.

FIG. 24 is a side view of an inner vessel along I-I of FIG. 23.

FIG. 25 is a trimetric view of the inner vessel of FIG. 21 in the open position.

FIG. 26 is a top view of a sixth embodiment of an inner vessel.

FIG. 27 is a cross-sectional view along J-J of the inner vessel of FIG. 26.

FIG. 28 is top view of a seventh embodiment of an inner vessel.

FIG. 29 is a cross-sectional view along K-K of the inner vessel of FIG. 28.

FIG. 30 is a side view of an eighth embodiment of an inner vessel made up of two circular components.

FIG. 31 is a cross-sectional view along L-L of FIG. 30.

FIG. 32 is a side view showing holes along the outer segment of the inner vessel.

FIG. 33 is a cross-sectional view of the inner vessel in FIG. 32 showing the holes of the inner component of the inner vessel offset from the holes of the outer component of the inner vessel.

FIG. 34 is a side view of a ninth embodiment of an inner vessel with slots.

FIG. 35 is a cross-sectional view along N-N of the inner vessel in FIG. 34.

FIG. 36 is trimetric view of the inner vessel of FIG. 34 shown in the closed position.

FIG. 37 is a perspective view of the inner vessel of FIG. 34 shown in the fully open position.

FIG. 38 is enlarged cross-sectional view of the assembly in FIG. 2, in which the outer container is not shown.

FIG. 39 is an enlarged view showing one example of a seal feature with a bump and groove configuration.

FIG. 40 is an enlarged showing a one example of a seal feature with a bump and groove configuration.

FIG. 41 is an exploded trimetric view of the assembly in FIG. 2 showing a seal pattern that forms an inner cavity that is separate from the outer cavity which is formed between the inner vessel and outer container.

FIG. 42 is an exploded trimetric view of the assembly in FIG. 2 showing a potential seal pattern that forms an inner cavity that is separate from the outer cavity which is formed between the inner vessel and outer container.

FIG. 43 is an exploded view of an inner vessel similar to the one shown in FIG. 2 except that the tubes and covers are made from separate components then assembled together.

FIG. 44 is a trimetric view of the cover holding the stationary tube of the inner vessel.

FIG. 45 is a trimetric view of the stationary component of the inner vessel.

FIG. 46 is a trimetric view of the component of the inner vessel that is configured to rotate.

FIG. 47 is a trimetric view of the cover that attaches to the component of the inner vessel that rotates and provides locating features to indicate the fully open and the fully closed positions of the inner vessel.

FIG. 48 is a enlarged cross-sectional expanded view of the assembly depicting the components shown in FIG. 43.

FIG. 49 is exploded trimetric view of another embodiment of the assembly comprising four inner tubes.

FIG. 50 is top view of an outer container and four inner vessels.

FIG. 51 is a cross sectional view along R-R of the assembly in FIG. 50.

FIG. 52 is enlarged View S showing fine details of the assembly.

FIG. 53 is enlarged View T showing the lower inner vessel details.

FIG. 54 depicts one embodiment of the method of filling the assembly of FIG. 50.

FIG. 55 depicts another embodiment of the method of filling the assembly of FIG. 50.

FIG. 56 depicts yet a further embodiment of the method of the assembly of FIG. 1.

FIG. 57 is a cross-sectional view along U-U of the assembly in FIG. 58.

FIG. 58 is a top view of an embodiment of the assembly.

FIG. 59 is a trimetric view of the assembly in FIG. 58.

FIG. 60 is a cross-sectional view along V-V of the assembly in FIG. 58.

FIG. 61 is an exploded trimetric view of the assembly in FIG. 58.

FIG. 62 depicts a filling method for the assembly in FIG. 58.

FIG. 63 is a top view of an inner vessel with different sized radial openings.

FIG. 64 is a cross-sectional view along W-W of the inner vessel of FIG. 63.

FIG. 65 is a trimetric view of the inner vessel of FIG. 63.

FIG. 66 is a cross-sectional view along X-X of the inner vessel of FIG. 63.

FIG. 67 is a cross-sectional view along Y-Y of the inner vessel of FIG. 63.

FIG. 68 is an exploded trimetric view of the inner vessel of FIG. 63.

FIG. 69 is a trimetric view of the inner vessel in FIG. 63 with the rotating component rotated partially such that the upper compartment is open and the lower compartment is still closed.

FIG. 70 is a trimetric view of the inner vessel in FIG. 63 with the rotating component rotated such that the upper and lower compartments are open.

Like numerals refer to like parts throughout the several views of the drawings.

### DETAILED DESCRIPTION OF THE PREFERRED EMBODIMENTS

The multi-compartment mixing containers described herein provide a practical and cost-effective design for separately storing a plurality of components in a mixture, such as liquids, powders, gels, granular materials, or pellets, within a single outer container and for mixing the components together by rotating the inner vessel(s) to reveal an opening and shaking the outer container. Methods for assembling the multi-compartment containers and for filling a multi-compartment container comprising a plurality of different components is further described herein.

In one embodiment, an outer container holds an inner vessel via a common cover allowing two components of a mixture to be kept separate. The inner vessel is made of two mostly semi-circular sections coupled to one another to define an enclosed cavity. In a preferred embodiment, the semi-circular sections comprise a first section being configured to rotate and the second section being fixed relative to the first, the rotation of the first and second sections permitting the inner vessel to be actuated between an enclosed configuration to contain and segregate out the contents of the inner vessel from the surrounding and an open configuration to allow the contents of the inner vessel to be released into its surrounding. In alternate embodiments, both first and second sections may be rotatable relative to one another and relative to a fixed outer container.

As described above, in the closed position, the first and second sections of the inner vessel form an enclosed space able to hold one component of a mixture separate from another component. In the open position and or partially open position, one of the inner vessel components is rotated around the stationary component creating an opening to allow the different mixture components to mix. While the inner vessel is described as comprising two sections, it is understood that the inner vessel may comprise more than two sections, provided that the inner vessel may be configurable to be actuated between a fully enclosed and an open configuration.

Embodiments in which the inner vessel comprises two sections, the stationary one of the two sections may either be fixed to or integrated into the bottom portion of the outer vessel. Alternatively, the stationary one of the two sections may also be fixed to or integrated into a lid that is configured to engage an open mouth of the outer vessel.

One section constituting the inner vessel may comprise a separating web and a lower cap that permits two different components to be maintained separately within a single inner vessel. With the outer container housing a third component, this configuration permits up to three different components to be separately stored within a single outer container.

In a further embodiment, the two sections of the inner vessel may be provided in a semi-circular shape such that the sections may be rotated to define an enclosed cylinder in one configuration and also rotated to define an open semi-circular shape in another configuration to release the contents stored within the inner vessel.

In yet a further embodiment, the inner vessel may comprise two concentric sections, such as two concentric cylinders. The two concentric cylinders may each have one or a plurality of spaced apart holes or apertures in which one or both of the concentric cylinders may be rotated to line up the respective holes or apertures to permit fluid communication between the interior and exterior of the inner vessel and thus permit the contents of the interior vessel to be released. One or both of the concentric cylinders may be rotated to remove the respective holes or apertures of the concentric cylinders from alignment to a fully enclosed configuration.

In another embodiment, the top portion of the inner vessel comprises an activated opening through which the mixed components may be poured or consumed. The activated opening is effective to permit the mixed components of the outer container and inner vessel to be consumed when the inner vessel is in an open configuration. The activated opening may be a baby nipple or any of a number of standard openings such as a peel top, snap top, or similar activated opening.

In a further embodiment, multiple inner vessels may be incorporated into one outer container with a separate opening in the lid available for consuming the mixture.

While the multi-compartment container has been described as constituting one inner vessel, it is understood that any number of inner vessels may be provided within the outer container. Such embodiments are within the scope of this disclosure.

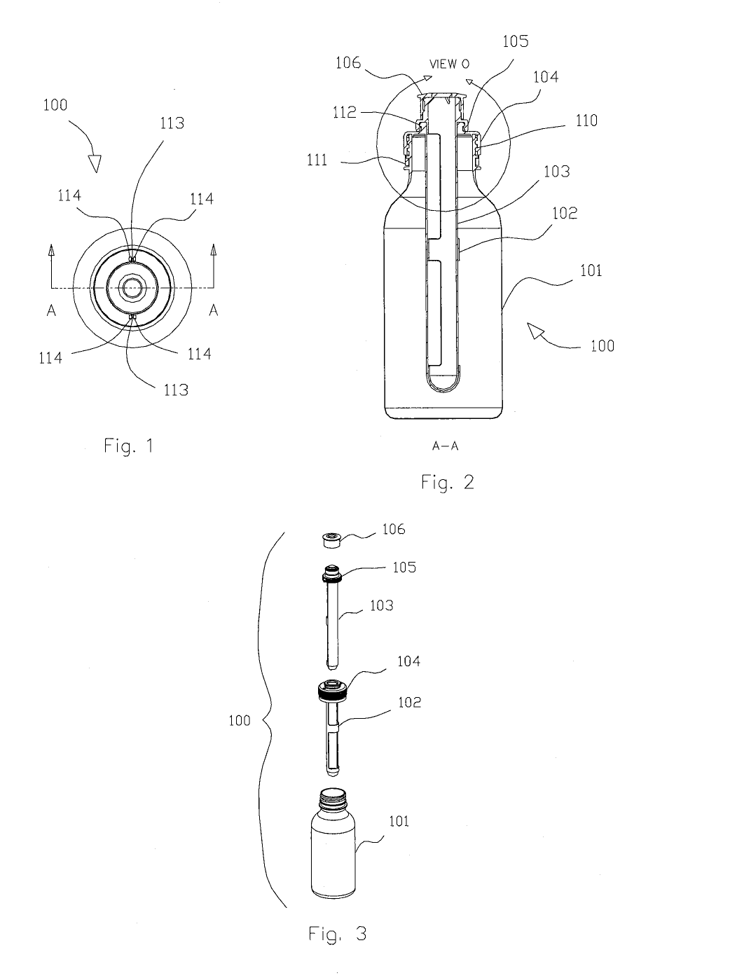

FIGS. 1-3 depict a multi-compartment mixing container 100 comprised of an outer container 101 and an inner vessel comprising two sections 102 and 103. The stationary section 102 has an integral cover 104 with a tamper evident ring 111. The cover 104 also mates to the rotating cover via snap features 112. The inner vessel further comprises a rotating component 103 having an upper rotating mechanism 105 that also mates with a closure 106. The rotating cover 105 has dial feature 113 that extends to positively locate the closed and fully open positions of the inner vessel. The cover 104 has a corresponding index 114 to indicate the position of the dial feature 113 of the rotating cover to indicate whether the inner vessel is in a fully enclosed position or an open position. It is understood that, a baby nipple may be used with a retaining ring to replace the closure 106.

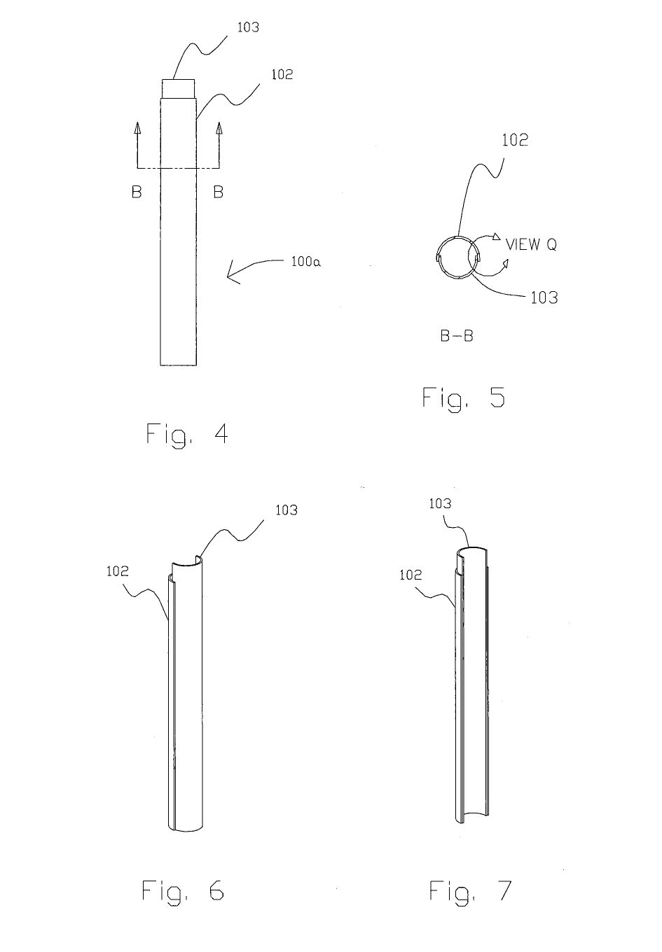

FIGS. 4-7 depict various embodiments of an inner vessel 100a comprised of two semi-circular components 102 and 103 with FIGS. 5 and 6 showing the inner vessel in the closed position and FIG. 7 showing the inner vessel in the fully open position. FIGS. 4-7 depict the inner vessel as a cylinder and it is understood that the top and bottom open portions are enclosed when assembled in the outer container. In one embodiment, one of the two semi-circular components 102, 103 is coupled to the bottom while the other one of the two semi-circular components 102, 103 is coupled to the lid. The top and bottom open portions are sealed with respect to the lid and the bottom surface of the outer container (not shown).

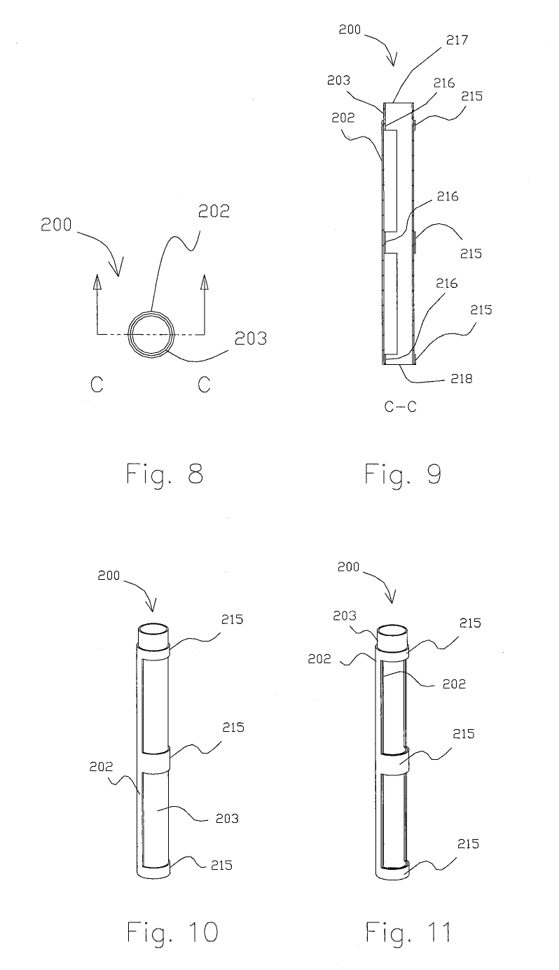

FIGS. 8-11 depict another embodiment of an inner vessel 200 comprising two concentric sections 202 and 203. Reinforcing bands 215 and 216 are provided by the outer concentric section 202 and the inner vessel 200 defines an open bottom 218 that is sealably engaged to the bottom surface of the outer container (not shown). The upper opening 217 of the inner vessel is sealably engaged to the surface of the lid that is coupled to the outer container. In the embodiment shown in FIGS. 8-11, the inner section 203 may be rotated relative to the outer section 202 so as to alternatively define an opening in the inner vessel 200 or to define a completely enclosed inner vessel 200. An impermeable web may alternatively be provided between the two openings defined by the inner and outer sections 202 and 203 so as to permit the storage and segregation of two different components within the inner vessel 200. While the embodiment depicted in FIGS. 8-11 depict that the two openings are opened simultaneously, it is understood that only one of the two openings may be provided at one time by staggering the location of the openings in either one or both of the inner or outer sections 202, 204.

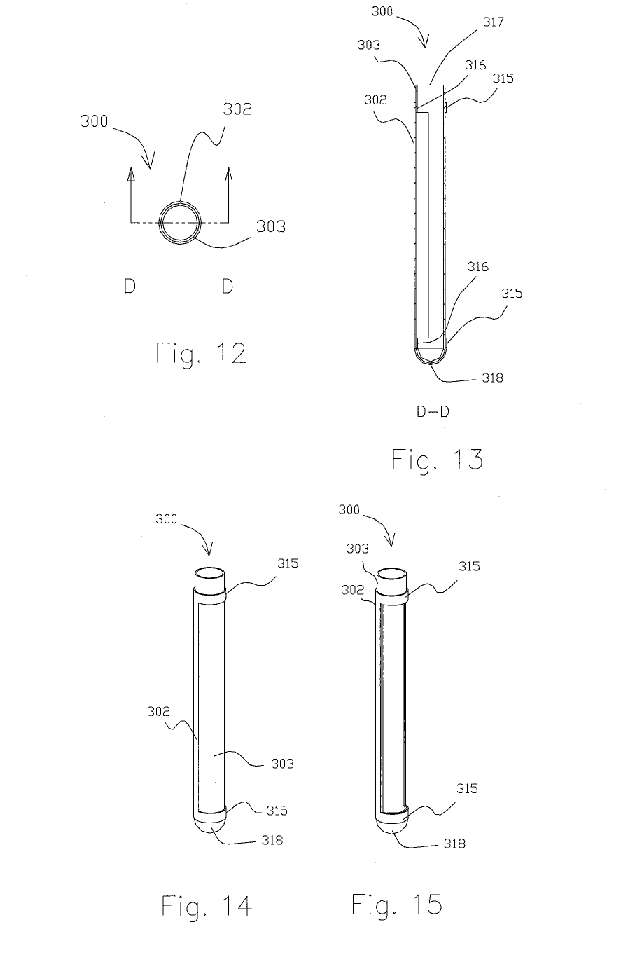

FIGS. 12-15 depict another embodiments of an inner vessel 300 comprised of two mostly circular sections 302 and 303 with reinforcing bands 315 and 316 and a closed bottom 318. The upper opening 317 of the inner vessel is also shown. In this embodiment, the inner vessel 300 need not be sealably engaged with the bottom surface of an outer vessel in order to form an enclosure. Therefore, the inner vessel 300 may be suspended within the outer container. The two sections 302 and 303 are coupled to outer and inner portions of the lid (not shown) which, in turn, may be rotated relative to one another so as to control the rotation of the two sections 302, 303 to an open or closed configuration.

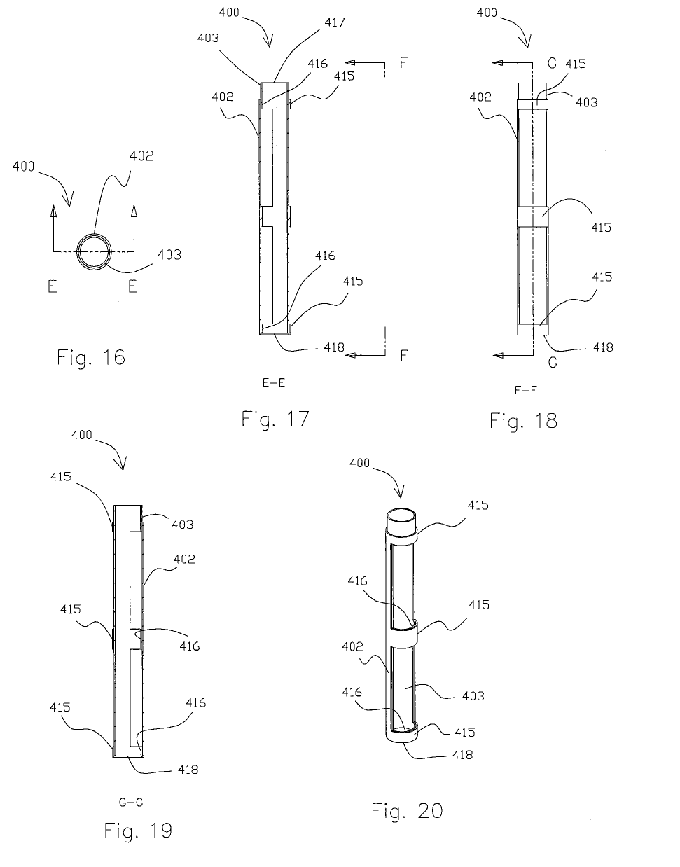

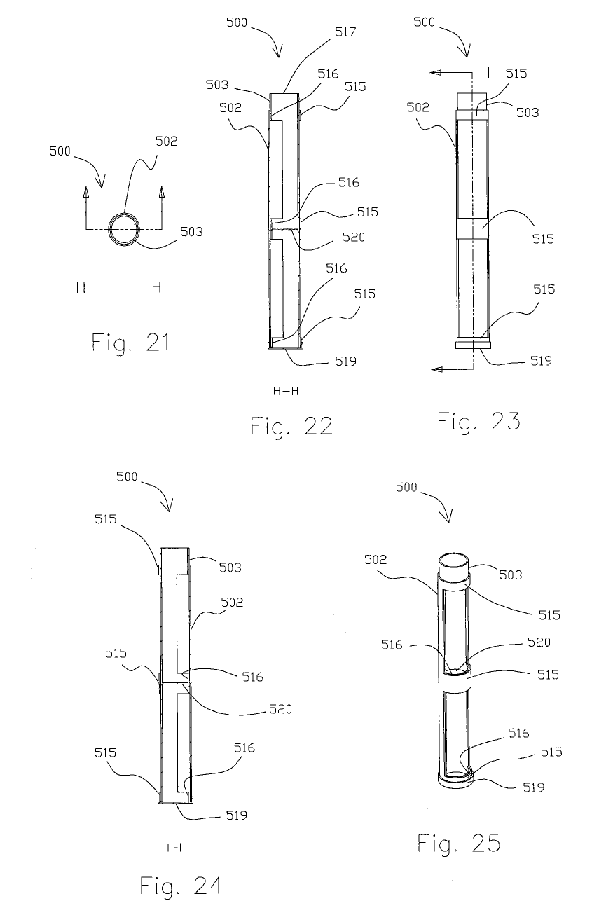

FIGS. 16-20 depict another embodiment of an inner vessel 400 comprising semi-circular section 402 and 403 with reinforcing bands 415 and 416 and a closed bottom 418 that is part of the outer component 402 of the inner vessel. The upper opening 417 of the inner vessel is also shown. In contrast to the inner vessel 200 depicted in FIGS. 8-11, the inner vessel 400 comprises a closed bottom 418 that is formed by the outer section 402 and thus the inner vessel 400 need not be engaged to the bottom surface of the outer container (not shown).

FIGS. 21-25 depict another embodiment of an inner vessel 500 comprising two semi-circular sections 502 and 503 with reinforcing bands 515 and 516 and a separate closure at the bottom 519 that is mated to the outer section 502 of the inner vessel. An optional membrane 520 is also shown which will allows two compartments to be formed in the inner vessel 500. The upper opening 517 is also shown.

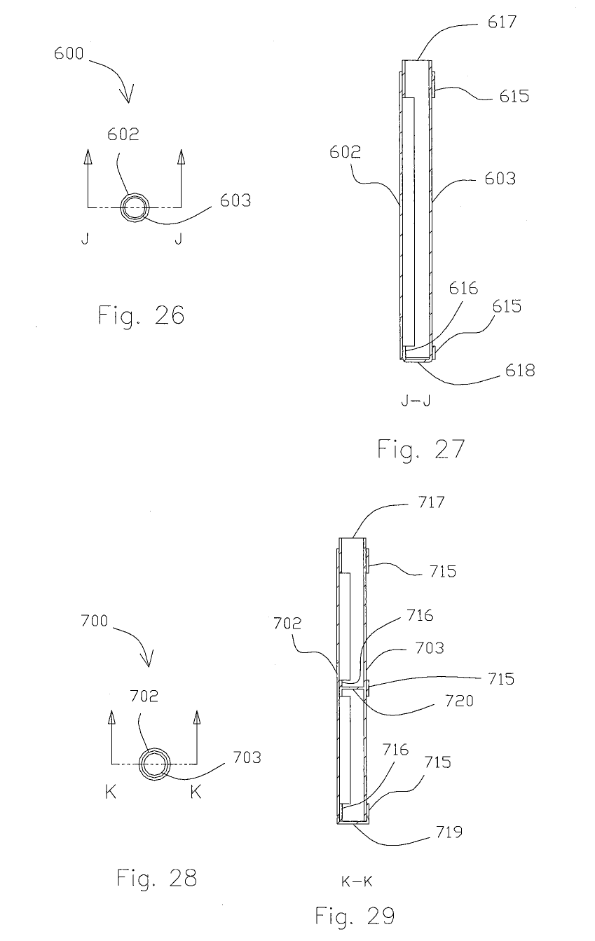

FIGS. 26-27 depict another embodiment of an inner vessel 600 comprising two semi-circular sections 602 and 603 with reinforcing bands 615 and 616 and a closed bottom 618 that is formed from the inner component 603 of the inner vessel. The upper opening 617 of the inner vessel is also shown.

FIGS. 28-29 depict another embodiment of an inner vessel 700 comprising two semi-circular sections 702 and 703 with reinforcing bands 715 and 716 and a separate closure 719 that is mated to the rotating component 703 of the inner vessel. The upper opening 717 of the inner vessel is also shown. An optional membrane or divider 720 is depicted that would allow two compartments to be formed in the inner vessel 700. The divider 720 may be formed from the inner wall of the inner section 703.

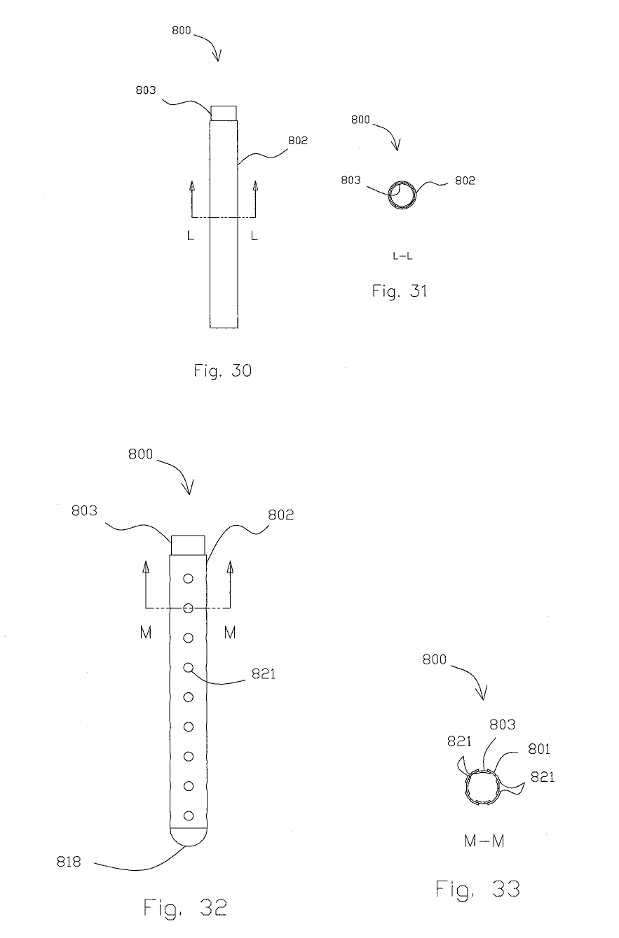

FIGS. 30-33 depict an inner vessel 800 made up of concentric cylindrical inner 803 and outer 802 sections. FIGS. 30-31 illustrate the concentric cylinders 802, 803 without hoes and FIGS. 32-33 illustrate the concentric cylinders 802, 803 each comprising a plurality of holes 821 and rotation of either one or both of the inner and outer sections 802, 803 relative to one another either aligns the holes so as to permit fluid communication between the inner vessel 800 and the outer container (not shown) or it covers the holes 821 so as to provide a complete enclosure of the inner vessel 800 (FIG. 33).

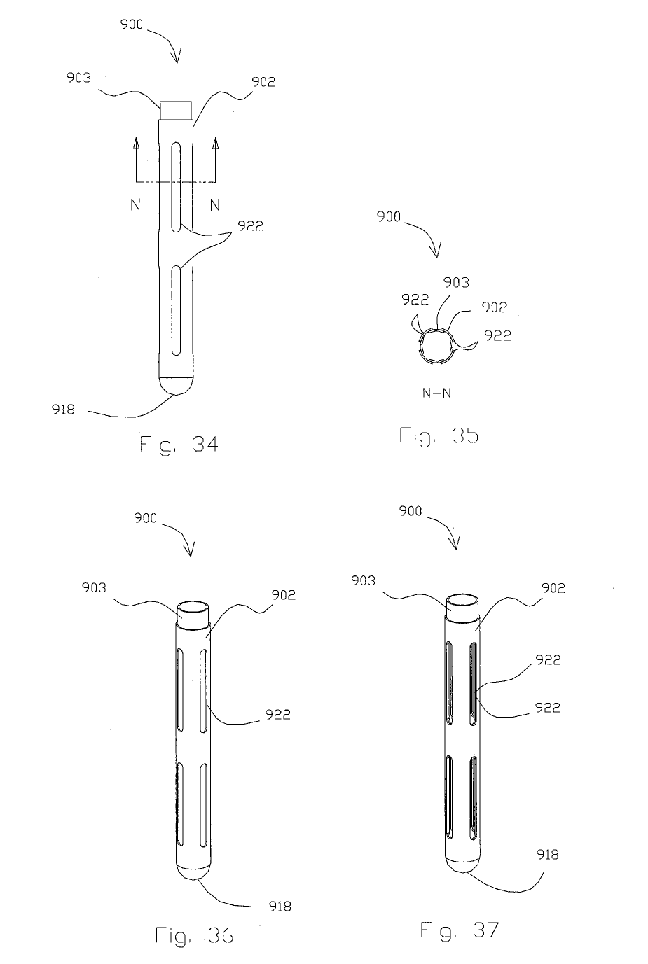

FIGS. 34-37 depict an inner vessel 900 made up of concentric cylindrical sections 902 and 903 each having slots 922 along their axis. FIG. 34 illustrates the outer slots 922 while FIG. 35 illustrates the cross-section of the inner 903 and outer 902 components of the inner vessel 900 in the closed position. A closed bottom 918 is also shown. FIG. 36 illustrates the inner vessel 900 in the closed position while FIG. 37 illustrates the inner vessel 900 in the fully open position. Various configurations of perforations on the stationary and rotating components of the inner vessel are be envisioned such that rotating one component would open the inner vessel to the outer container.

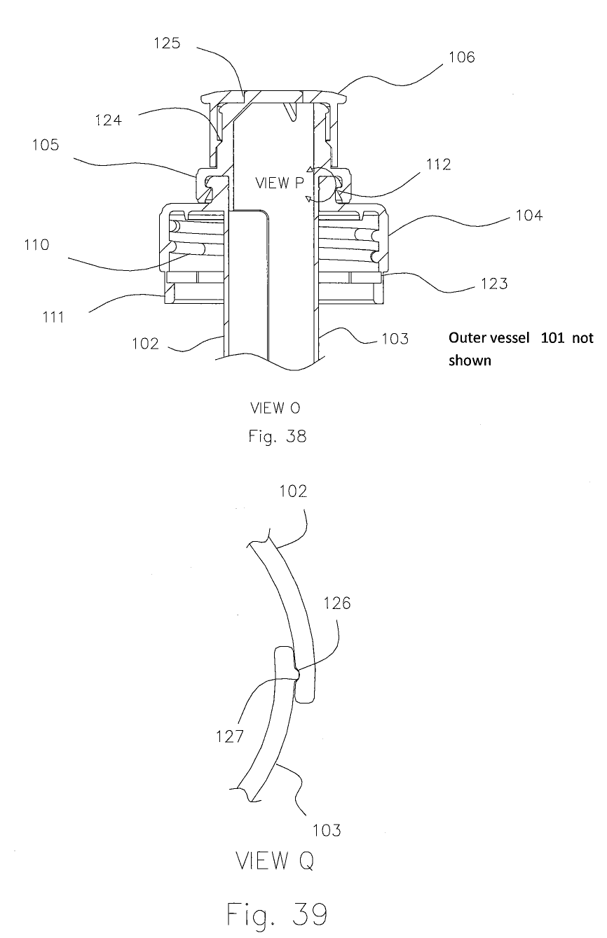

FIG. 38 is a cross-section view of the assembly of FIG. 1. The tamper evident ring 111 is held on by thin features 123. Threads 110 hold the cover 104 to the outer container 101 (not shown). Snap features 112 hold the rotating cover 105 to the stationary cover 104. The vertically activated closure 106 may travel along the extent of feature 124. The closed configuration forms a seal at 125.

FIG. 39 is an exploded view that illustrates a longitudinal seal formed along the length of the vessel by a bump 127 and a groove 126. Embodiments in which the inner vessel is used to house a liquid will require a leak-proof seal to be formed between the outer and inner sections 102, 103 when the two sections are moved into an open position. This may be accomplished by a mating bump 127 and groove 126 disposed on the inner 103 and outer 102 sections respectively. It is understood that the mating bump 127 and groove 126 may be disposed on the outer 102 and inner 103 sections, respectively. In a preferred embodiment, the bump and groove is provided along substantially the entire longitudinal length of the inner vessel. In an alternative embodiment, a plurality of bumps may be provided, in which there may be one bump on one section and two bumps on the other component that straddle the first bump to form a seal. If the two sections 102 and 103 are made of relatively rigid materials such as glass, then a polymer coating or band may be used to approximate the bumps.

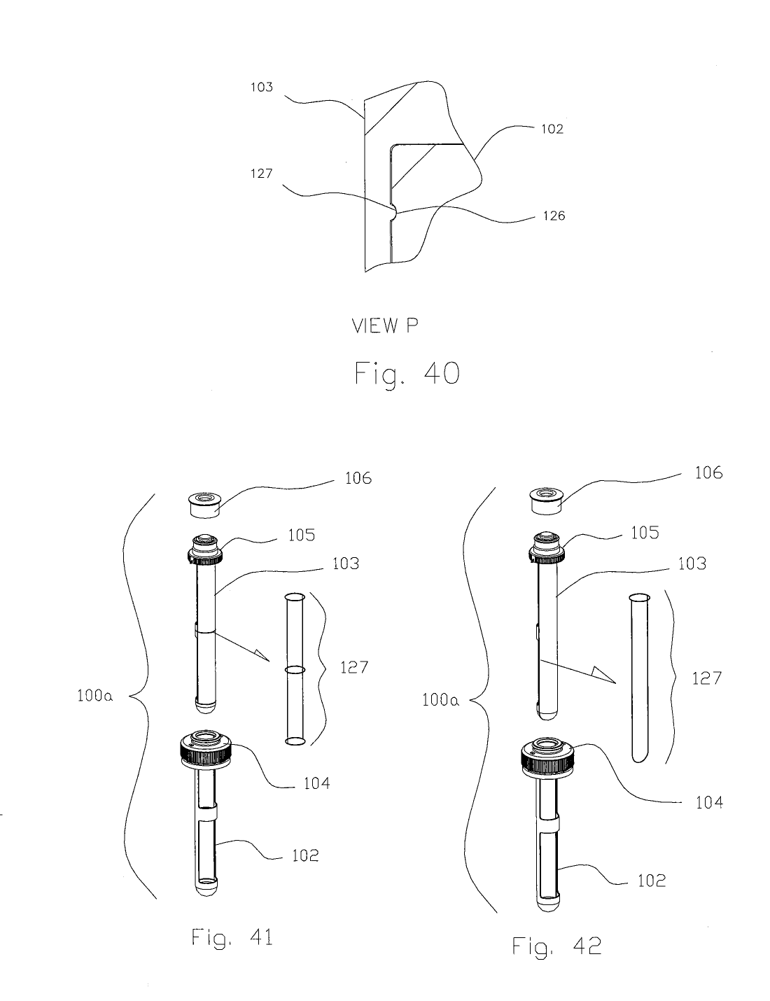

FIG. 40 illustrates a circumferential seal that is formed when one section 102 comprises a groove 126 and the other section 103 comprises a bump 127.

FIG. 41 illustrates one example of a circumferential seal 127 that may be used to form a seal between the non-rotating component 102 and the rotating component 103 of the inner vessel 100a.

FIG. 42 illustrates another example of a circumferential seal 127 that may be used to form a seal between the non-rotating component 102 and the rotating component 103 of the inner vessel 100a.

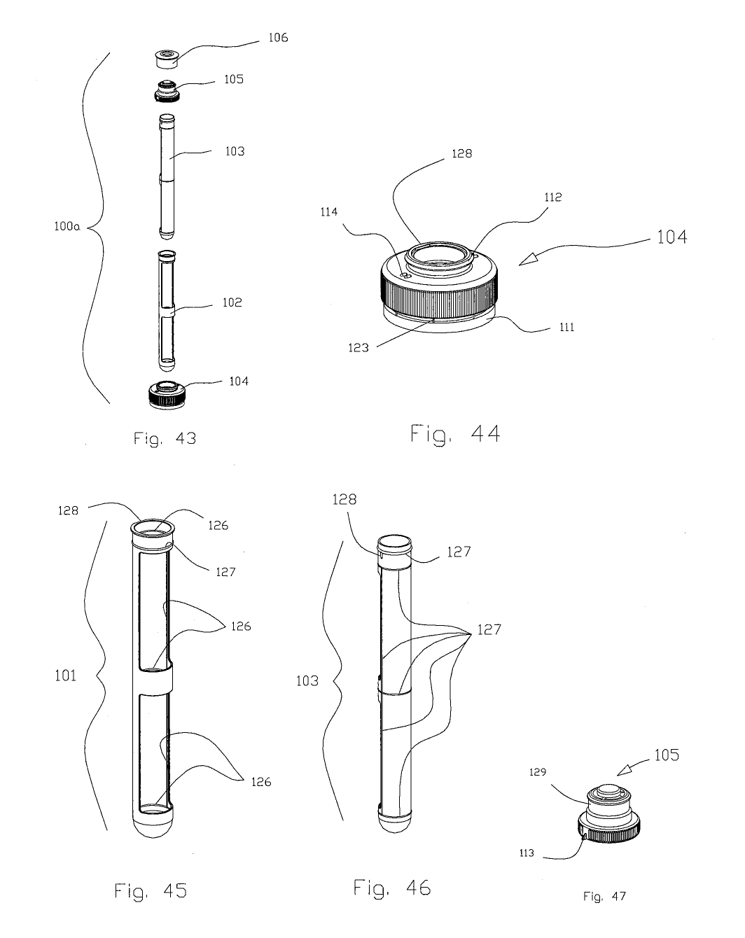

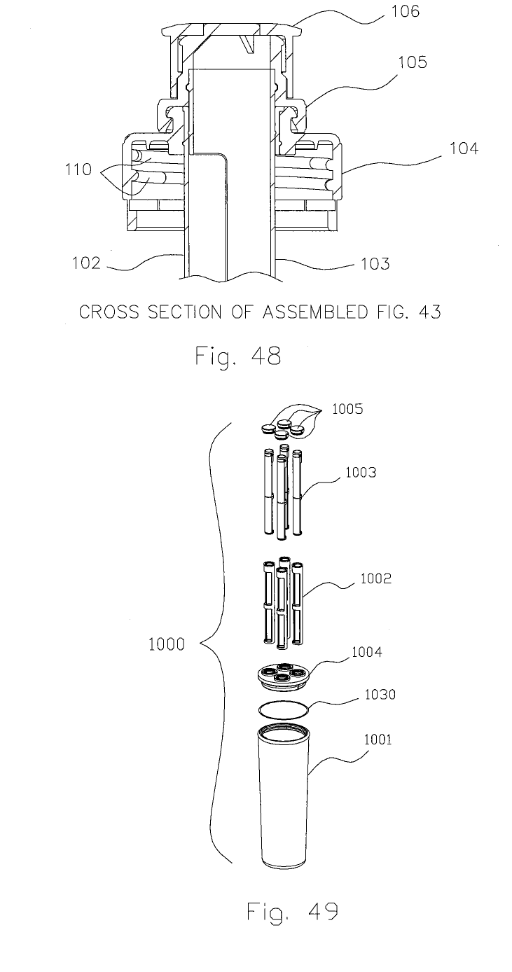

FIG. 43 illustrates the inner vessel 100a being made up of 5 parts, namely the non-rotating tube 102, the stationary cover 104, the rotating tube 103, the rotating cover 105 and the closure 106. The non-rotating cover 104 has a snap feature 112 to allow mating with the rotating cover 105 and feature 128 that prevents the rotation of the non-rotating tube 102. The tamper evident ring 111 is held on to the non-rotating cover by thin sections 123. The non-rotating cover 104 also has indexing/locating features 114 to locate the rotating cover as shown in FIG. 44.

The inner tube 102 of FIG. 45 has a flange with a flat section 128 that prevents rotation when mated to the cover 104. The inner tube 102 also has grooves 127 that will mate with the bumps 127 on the rotating tube 103 of FIG. 46. The non-rotating tube 101 of FIG. 45 also has bumps 127 to form seals between itself and the non-rotating cover 104. The rotating cover 105 has indexing features 113 and a travel limiting feature 129 when mated to the closure 106.

FIG. 48 illustrates the inner vessel assembly of FIG. 43 in the assembled state. The cross-section of FIG. 48 also illustrates the threads 110.

FIG. 49 is an exploded view of an assembly 1000 with an outer container 1001, stationary components 1002 of inner vessels, rotary components 1003 of the inner vessel, a non-rotating cover 1004, and closures 1005. Depending on the materials used, a seal 1030 may be necessary between the cover 1004 and outer container 1001.

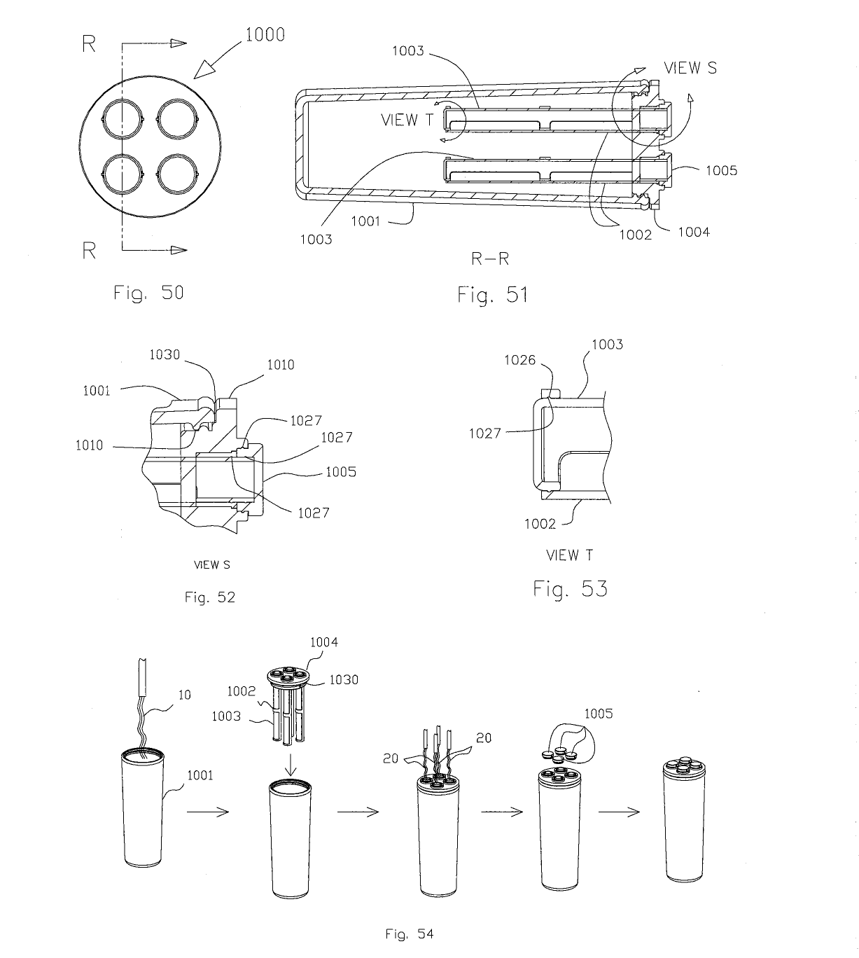

FIGS. 50-53 illustrate various features of the assembly 1000. An outer container 1001 is shown with stationary inner vessel components 1002 and rotating inner vessel components 1003. The inner vessel covers 1005 mate securely with the inner vessel components 1003 and the non-rotating cover 1004. Depending on what materials are used, a seal 1030 may be necessary. Several sealing features are shown made up of bumps 1027 and grooves 1026.

FIG. 54 illustrates one example filling method of assembly 1000. First, the outer container 1001 is filled with a first component 10. Then, the inner vessels 1002 and 1003 are assembled along with the non-rotating cover 1004 to the outer container 1001. Then the inner vessel(s) are filled with additional components 20 prior to closing the inner vessel with their covers 1005. An optional tamper evident shrink film (not shown) may be used to cover the inner vessel covers 1005.

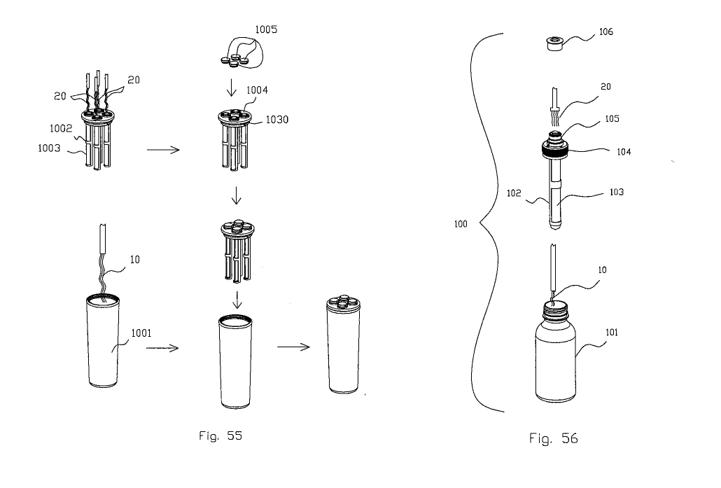

FIGS. 55 and 56 illustrate another preferred filling method of assembly 1000. The outer container 1001 is first filled with a first component 10. The assembled inner vessels 1002 and 1003 along with the stationary cover 1004 are filled with their respective components 20 and the inner vessel covers 1005 are then mated to the inner vessels. The inner vessel assembly is then mated to the outer container 1001 and a tamper evident seal may be added. The consumer may remove the tamper evident film, rotate the rotating covers 1005 from the closed position to the open position, shake the assembly to assure good mixing, then twist open the cover 1004 to pour or consume the mixture directly from the outer container 1001.

FIG. 56 illustrates a preferred filling method for assembly 100. The outer container 101 is first filled with one component 10. The assembled inner vessel made up of non-rotating component 102 and rotating component 103 is filled with another component 20 then a closure 106 is mated to the non-rotating cover. Finally, the inner vessel assembly is mated to the outer container 101. The consumer may remove the tamper evident shrink film (not shown), rotate the rotating cover 105 from the closed position to the open position, shake the assembly vigorously then pull the closure 106 open to pour or consume the mixture directly.

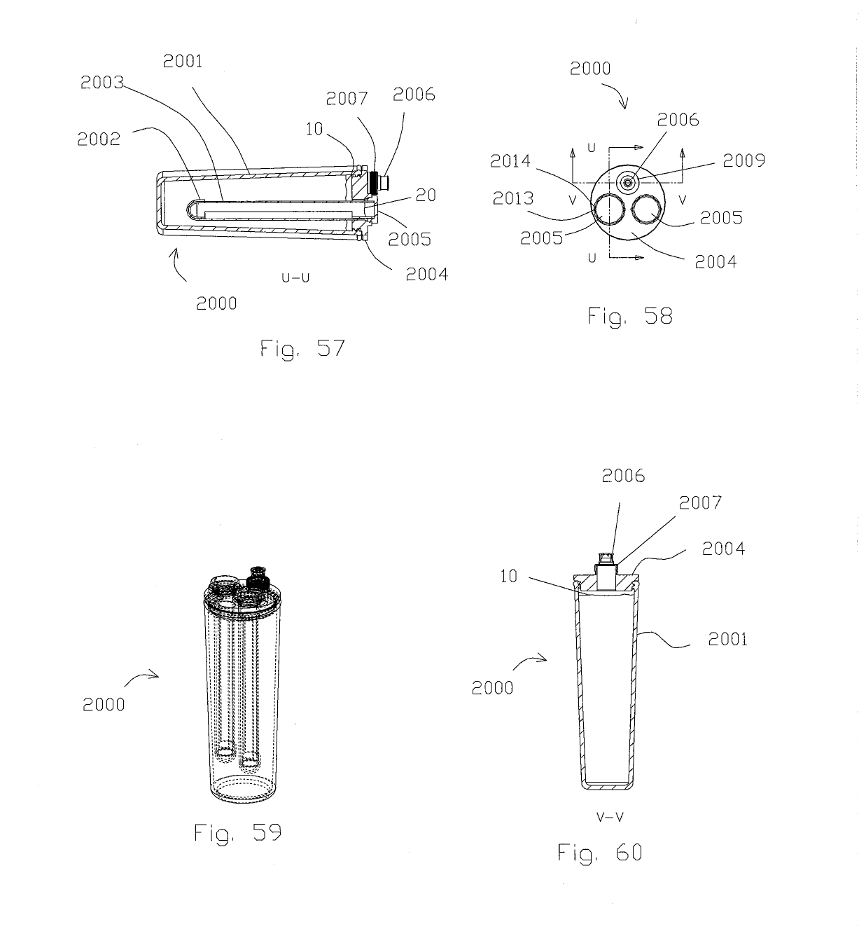

FIGS. 57-60 illustrate an assembly 2000 consisting of a single outer container 2001 and two inner vessels each made up of a non-rotating section 2002 and a rotating section 2003. A cover 2004 holds the inner vessels and a closure 2006 to the outer container 2001. The closure 2006 is held onto the cover via a lower ring 2007. Rotating closures 2005 mate to the inner vessels. Up to three components of a mixture 10 and 20 may be contained in this configuration.

The assembly 2000 shows the outer container 2000 in which the cover 2004 comprises a fixed portion 2002 and a rotatable portion 2003. The structure designated as 2005 is the inner vessel closure that also mates to the rotatable portion 203 and an opening 2006 is provided that slides up and down. The base 2007 of the closeable opening is configured to screw or affix onto the cover 2004. The mixture may be consumed from the opening area 2009. Moreover, locking features 2014 are provided that indicate the closed and open positions and protrusion 2013 disposed on the cover 2004 mate with one another to indicate open and closed positions.

One advantage of this design is that it permits the inner vessels to be filled separately and capped with a cover 2005, which is mated to the inner compartment of the inner vessel such that the inner vessel and attached cover 2005 rotate together. There are features that permit the snap fit ability of the two components of the inner vessel.

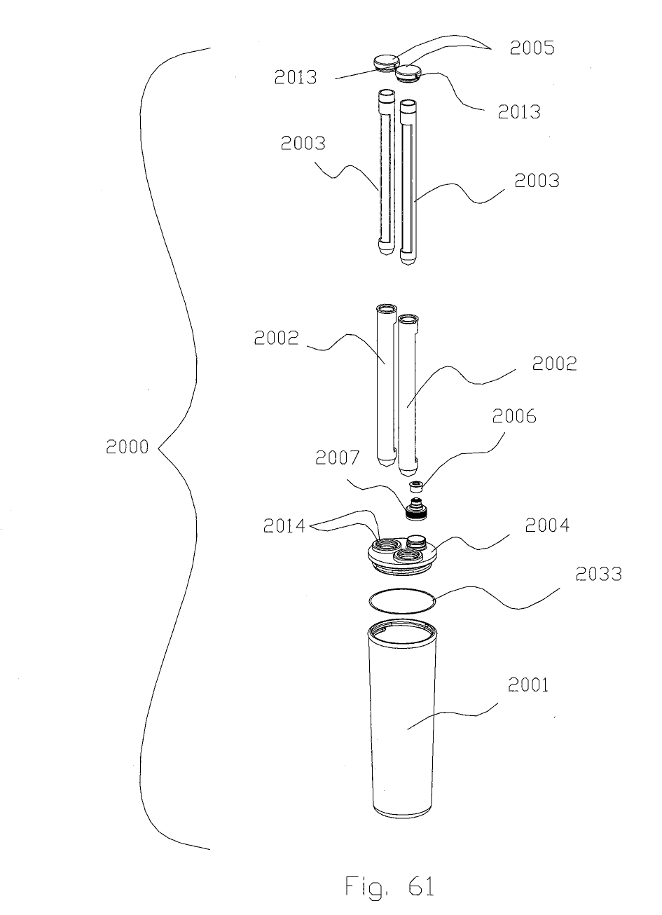

FIG. 61 illustrates an exploded view of an assembly 2000. Depending on the materials used additional seals 2033 may be required.

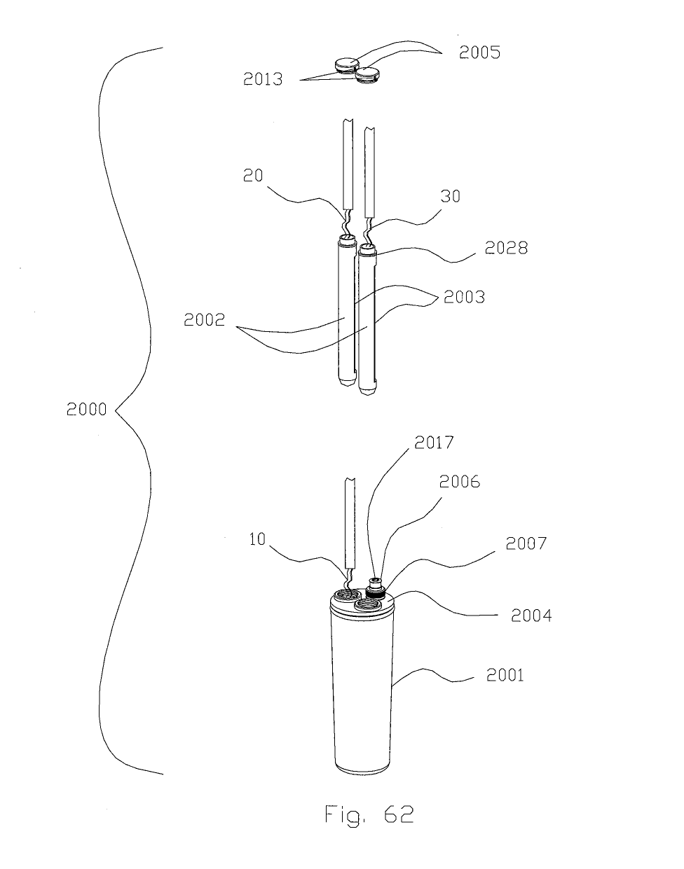

FIG. 62 illustrates a filling method. The outer container 2001 is mated to the cover 2004 and the actuated opening 2006 and 2007 and filled with mixture component 10. The inner vessels' components 2002 and 2003 are pre-assembled, filled with a component mixture 20, then closed with the rotating closure 2005. There are indexing locating features 2013 that indicate the fully closed and fully open positions. Once the inner vessels are filled, they may be mated to the outer container 2001 and a tamper evident shrink film (not shown) may be applied. The consumer may first remove the tamper evident film, rotate the inner vessels' rotating rings 2005 from the closed to the open position, shake vigorously, then pull the actuated opening 2006 to pour or consume directly from the opening 2017. In FIG. 62, it is shown that the actuated opening 2006, 2007 does not correspond to one of the inner vessels but rather communicate directly with the outer container 2001. It us understood that in any of the embodiments illustrated herein, the location of the opening on the lid, be it nipple or actuated opening in the form depicted in FIG. 62, may correspond directly to one of an inner vessel or with the outer container directly.

When the various Figures are taken together, various combinations may be put together. For instance, the bottom of each inner vessel may be closed within the inner vessel components themselves or when sealed against an outer container. Depending on the number of openings and location of the openings, it may be required to rotate the rotating component of the inner vessel as little as 5 degrees or as much as 180 degrees. In some cases, such as configurations 100 and 100a the final mixture is designed to exit via the inner vessel or vessels. In other configurations, namely 2000 the final mixture is designed to exit via a dedicated exit opening other than the inner vessel or vessels or by removal of the cover and inner vessels completely.

Alternatively, the entire assembly 100 minus the outer container 101 may be sold to be retrofit to existing containers converting those containers into mixture capable vessels. In some cases, very small vent holes may be added to ease evacuation of the mixture such as in the case of assemblies 100, 100a, and 2000.

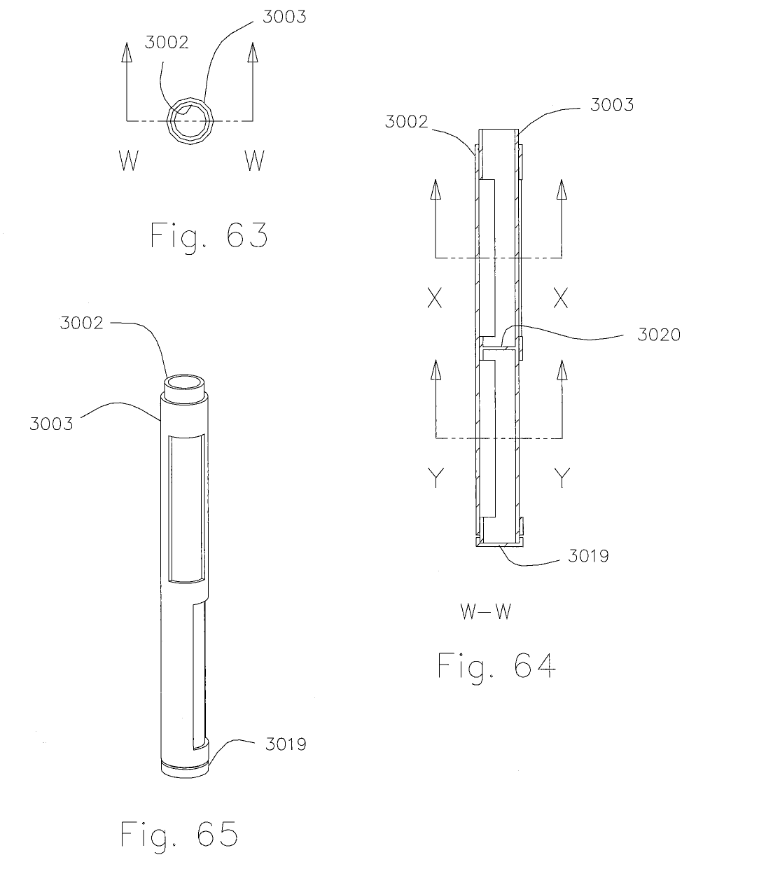

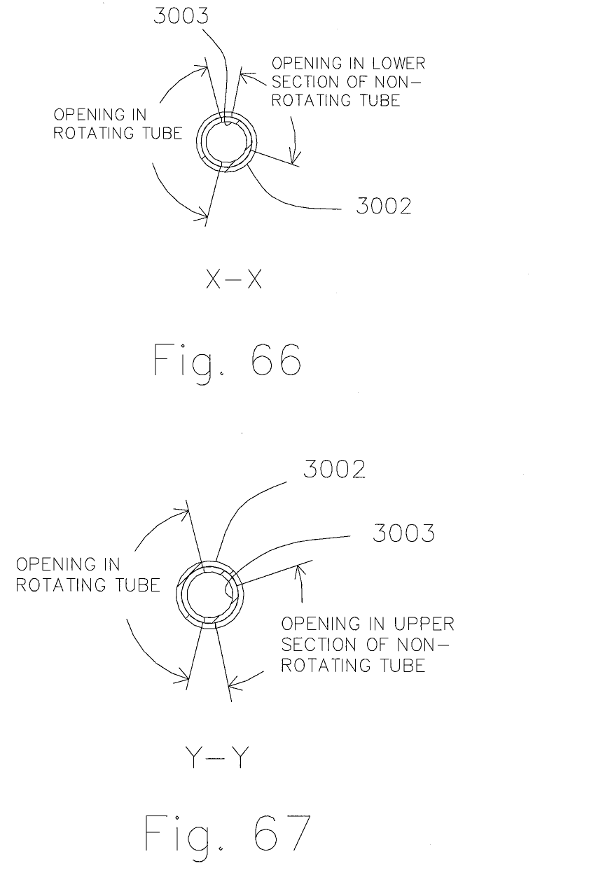

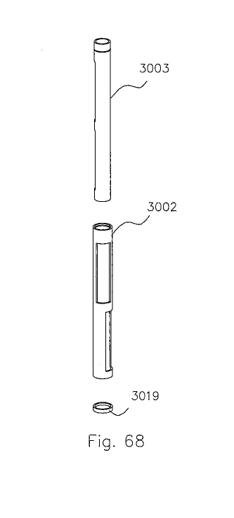

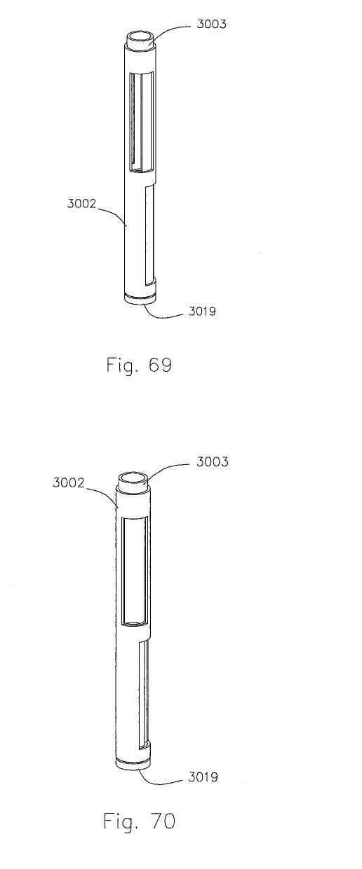

FIGS. 63-70 depict an inner vessel similar to the inner vessel of FIG. 26 except with various radially sized openings in the non-rotating component of the inner vessel. Alternatively the rotating component may also have various radially sized openings such that one of the compartments may be opened first prior to opening the second compartment. This inner vessel configuration has a non-rotating component 3002 and a rotating component 3003, a lower closure cap 3019 and a separating web 3020 that forms two inner compartments, an upper and lower compartment. FIG. 66 illustrates a partial rotation (approx. 70 deg for this configuration of radial openings) that opens the upper compartment but leaves the lower compartment still relatively closed. FIG. 67 illustrates a relatively full rotation (approx. 170 deg for this configuration of radial openings) that opens up both compartments. This concept may be useful for example where some customer desiring some components of a mixed drink but not another or when mixing one component first is conducive to producing a better mixture prior to mixing another component.

What is claimed is:

1. A multi-component mixing device comprising:
an outer container;
one or more inner vessels disposed in said outer container, said inner vessel each having a top portion, a bottom portion and a peripheral side wall between said top portion and bottom portion, the peripheral side wall being defined by first and second sections, the first and second sections being slidably engaged to one another between a first position and a second position;
wherein in said first position, inner vessel defines an enclosed cavity; and
wherein in said second position, inner vessel comprises a first opening corresponding to the enclosed cavity.

2. The multi-compartment mixing device of claim 1, further comprising a lid adapted to engage and seal the mouth of the outer container.

3. The multi-compartment mixing device of claim 2, wherein the lid comprises an outer portion directly coupled with the outer container and an inner portion directly coupled to one of the first and second sections of the inner vessel

4. The multi-compartment mixing device of claim 3, wherein the other one of the first and second sections of the inner vessel is coupled to one of the outer portion of the lid or the closed end of the outer container.

5. The multi-compartment mixing device of claim 4, wherein the inner portion of the lid is rotatable along a longitudinal axis relative to the outer portion to actuate one of the first and second sections of the inner vessel between the first and second positions.

6. The multi-compartment mixing device of claim 5, wherein the lid further comprises an index to designate the first and second positions.

7. The multi-compartment mixing device of claim 5, wherein the index is dial configured on the lid.

8. The multi-compartment mixing device of claim 1, further comprising a seal between the first and second sections, wherein the seal is fluid-proof, powder-proof or gel-proof.

9. The multi-compartment mixing device of claim 2, further comprising a fill hole and a closure to seal the fill hole.

10. The multi-compartment mixing device of claim 2, wherein one of the first and second sections is coupled to the closed end of the outer container and the other one of the first and second sections is coupled to the lid.

11. The multi-compartment mixing device of claim 1, wherein the inner vessel comprises a divider between the top and bottom portions and wherein in the first position, the inner vessel comprises two discrete cavities.

12. The multi-compartment mixing device of claim 10, wherein in said second position, the peripheral side wall comprise a first opening corresponding to a first one of the two discrete cavities.

13. The multi-compartment mixing device of claim 11, wherein said inner vessel comprises a third position, wherein in said third position, the peripheral side wall comprises a second opening corresponding to a second one of the discrete cavities.

14. The multi-compartment mixing device of claim 12, wherein in said third position, the first opening corresponding to the first one of the two discrete cavities is closed.

15. The multi-compartment mixing device of claim 1, where the inner vessel comprises a plurality of discrete enclosed cavities.

16. The multi-compartment mixing device of claim 2, wherein the lid further comprises one of a mouthpiece or a nipple.

17. The multi-compartment mixing device of claim 15, wherein the mouthpiece is configured to be actuated between an open and a closed state.

18. A multi-component mixing device comprising:
an outer container;
one or more inner vessels disposed in said outer container, said inner vessel comprising concentric cylindrical sections which are rotatable relative to one another to a first and a second position;
wherein in said first position, inner vessel defines an enclosed cavity; and
wherein in said second position, inner vessel comprises an opening corresponding to the enclosed cavity.

19. The multi-component mixing device of claim 19, wherein the concentric cylinder sections each comprise one or more openings, wherein in said first position, the respective openings of the concentric cylinder sections are not aligned to define the enclosed cavity.

20. The multi-component mixing device of claim 19, wherein the concentric cylinder sections each comprise one or more openings, wherein in said second position, the respective openings of the concentric cylinder sections are aligned to define the opening.
